(19) United States
(12) Patent Application Publication
(10) Pub. No.: US 2013/0000526 A1
(43) Pub. Date: Jan. 3, 2013

(54) MATERIAL WRAPPER AND WORK PLATFORM

(76) Inventor: Thomas R. Mathieson, Louisville, CO (US)

(21) Appl. No.: 13/045,454

(22) Filed: Mar. 10, 2011

Related U.S. Application Data
(60) Provisional application No. 61/313,643, filed on Mar. 12, 2010.

(51) Int. Cl. F16M 13/02; B65D 85/46

(52) U.S. Cl. 108/42; 206/323; 206/322

(57) ABSTRACT

A work platform and material wrapper for a supply of tiles or shingles is provided. The work platform includes an underlying base and an upright member. The base is for supporting the supply and has a front side, a top surface and a bottom surface. The bottom surface is disposed intermediate of the front side and the top surface. The upright member extends from an end of the front side. The base and the upright member form a storage bay configured to support the supply in a substantially horizontal position away from the roof surface. The material wrapper includes a midsection and four or more branches. Each branch includes a base connected to the midsection and a top flap connected to the base opposite the midsection. The base further includes at least one side flap configured and arranged to mate with an adjacent side flap on an adjacent base.

### CROSS REFERENCE TO RELATED APPLICATIONS

This application claims priority under 35 U.S.C. §119(e) to U.S. Patent Application No. 61/313,643, filed Mar. 12, 2010, the entire disclosure of which is hereby incorporated herein by reference.

### BACKGROUND OF THE INVENTION

1. Field of the Invention

The present invention generally relates to a material wrapper and work platform. More specifically, the present invention relates to a material wrapper and work platform for a roof to assist a roofer and provide a safer, more convenient work environment.

2. Background Information

The roofing industry can be dangerous. Roofers use numerous tiles or shingles to cover a roof for a given roof repair or installation. Roofers often store a small supply of tiles or shingles on the roof while working. The main supply, however, is often stored on the ground and the roofer must descend off of the roof to replenish the working supply on the roof. This is time consuming and potentially dangerous, inasmuch as the most likely time for a fall to occur is during the process of climbing off and back on the roof Thus, the danger to the individual roofer is exacerbated by the frequency in which he or she must descend from the roof in order to replenish the working supply of shingles.

Attempts have been made to avoid this danger by setting a larger supply of tiles or shingles on a pallet and hoisting the pallet up to the roof. However, the pallet does not provide a secure or stable mechanism for lifting, since tiles or shingles may fall off the side of the pallet or the supply may shift causing the pallet to tip over while being hoisted. Even if the roofer were to somehow stock a larger supply of tiles or shingles on the roof, the roof is often at an incline, and, as such, securing as well as accessing the larger supply of tiles is difficult and problematic.

Roof holders for tiles or shingles, such as the device disclosed in U.S. Pat. No. 4,987,720, are known in the art. However, these holders do not have a large storage capacity and do little to solve the problem of supporting a larger supply on an inclined surface for ready accessibility.

In view of the above, it will be apparent to those skilled in the art that a need exists for an improved material wrapper and work platform for storing a working supply of shingles on a roof and for providing a safer, more convenient work environment. This invention addresses this need in the art as well as other needs, which will become apparent to those skilled in the art from this disclosure.

### SUMMARY OF THE INVENTION

A work platform and material wrapper for a supply of tiles or shingles is provided. The work platform includes an underlying base and an upright member. The base is for supporting the supply and has a front side, a top surface and a bottom surface. The bottom surface is disposed intermediate of the front side and the top surface. The upright member extends from an end of the front side. The base and the upright member form a storage bay configured to support the supply in a substantially horizontal position away from the roof surface. The material wrapper includes a midsection and four or more branches. Each branch includes a base connected to the midsection and a top flap connected to the base opposite the midsection. The base further includes at least one side flap configured and arranged to mate with an adjacent side flap on an adjacent base.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a partial cross-section of a work platform in accordance with a first embodiment of the present invention;

FIG. 2 is a front plan view of the work platform of FIG. 1 in accordance with the first embodiment of the present invention;

FIG. 3 is a partial cross-section of a bottom surface and a friction layer of the work platform in accordance with an embodiment of the present invention;

FIG. 4 is a partial cross-section of a work platform in accordance with a second embodiment of the present invention;

FIG. 5 is a top plan view of a material wrapper laid flat with traction members not shown in accordance with an embodiment of the present invention;

FIG. 6 is a top plan view of the material wrapper secured around a supply of tiles or shingles in accordance with the embodiment of the present invention; and

FIG. 7 is a partial cross-section of the material wrapper showing the traction members.

### DETAILED DESCRIPTION OF THE PREFERRED EMBODIMENTS

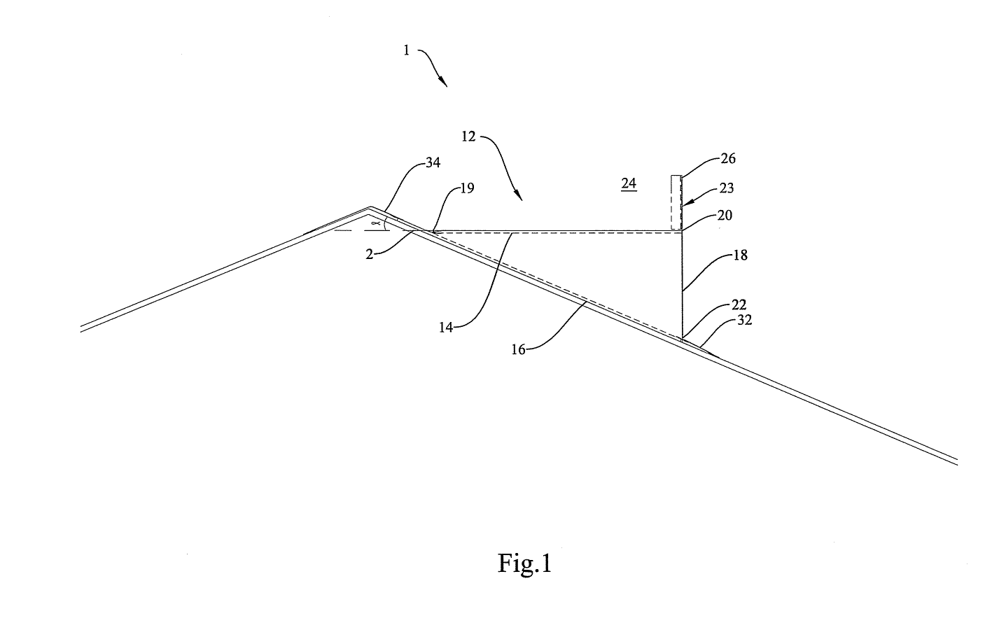

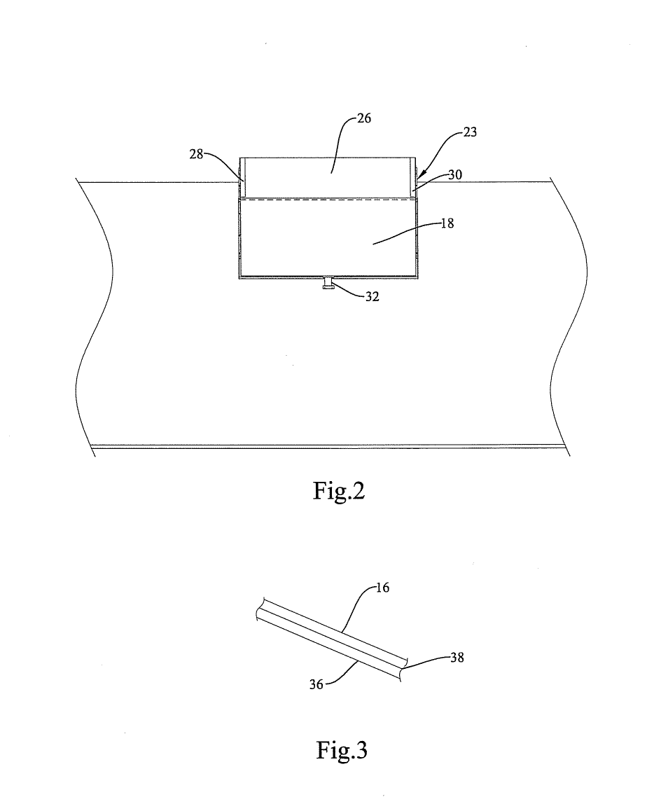

Referring initially to FIG. 1, a work platform 1 is illustrated in accordance with an embodiment of the present invention. The work platform 1 supports a supply of tiles, shingles or the like. The work platform 1 is constructed and arranged so that the supply of shingles does not rest on the roof surface 2. That is, the work platform 1 keeps the supply up off of the roof 2 and holds the supply closer to the roofer and closer to his center of gravity, thereby facilitating lifting and general access to the supply. The work platform 1 includes an underlying base 12 for supporting the supply. The base 12 includes a top surface 14, a bottom surface 16 and a front side 18, all of which are preferably substantially parallelogram shaped. In the embodiment of FIG. 1, the top surface 14 is substantially level or parallel with the ground. The bottom surface 16 is disposed intermediate the front side 18 and the top surface 14 at an angle α to follow the incline of the roof 2. The top surface 14 and the bottom surface 16 meet together at a crown end 19 of the platform 1. The front side 18 has a first end 20 connected to the top surface 14 and adapted to receive a bundle of shingles as will be described in greater detail below. The front side 18 also has a second end 22 connected to the bottom surface 16 adjacent the roof 2. The top surface 14 extends transversely and longitudinally so as to provide support for the entire shingle supply. The bottom surface 16 and the front side 18 also preferably extend transversely and longitudinally to support the working supply in a substantially horizontal position away from the roof surface.

The work platform 1 may include an upright member 23 for preventing the supply from skidding off of the base 12. The upright member 23 extends upwardly from the wrapper end 20 of the front side 18. The upright member 23 and the top surface 14 form a storage bay 24 therebetween. The storage bay 24 holds the supply and preferably includes enough area to hold a plurality of stacks of tiles or shingles. The upright member 23 further includes a gate 26 which spans the entire front side of storage bay 24, a first guard member 28 and a second guard member 30, the gate 26 curves or wraps around at an upper most end to secure the supply and prevent injury from a raw edge. The first and second guard members 28, 30 secure the gate 26 to the base 12 and provide rigid support for containing the supply within the storage bay 24. It will be apparent to one of ordinary skill in the art from this disclosure that the gate 26 may also be removed and the first and second guard members 28, 30 can be used without the gate 26.

The work platform 1 further includes a first secure extension 32 connected to the base 12 at the roof end of the front side 18 and a second secure extension 32 connected to the crown end 19 of the top surface 14 and/or bottom surface 16. The first secure extension 32 and the second secure extension 34 can be used to immobilize the work platform 1. The first secure extension 32 extends at an incline substantially parallel with the bottom surface and is preferably a thin rectangular bar having apertures at an end for securing to the roof. The thin rectangular first secure extension 32 is capable of fitting underneath tiles or shingles and can be nailed down using the same nails used to secure the tile or shingle to the roof.

The second secure extension 34 extends at an incline substantially parallel with the bottom surface 16 towards a crown of the roof 2 and is also preferably a thin rectangular bar having apertures at an end for securing to the roof 2. The end with apertures forms a curvature to match or substantially conform to the curvature at the crown.

Referring to FIGS. 1 and 3, an optional first friction layer 36 is disposed on the bottom of the bottom surface 16 to directly contact the roof 2 to prevent the base 12 from sliding down the incline. An adhesive layer 38 is disposed between the friction layer 36 and the bottom surface 16 to secure the friction layer 36 to the bottom surface 16. In addition, an embodiment of the present invention may include a second friction layer 39 disposed on the bottom of the first and/or second secure extension 32, 34. The first and second friction layers 36, 39 can be of an elastomeric material or any other material that provides a non-skid contact with the roof 2.

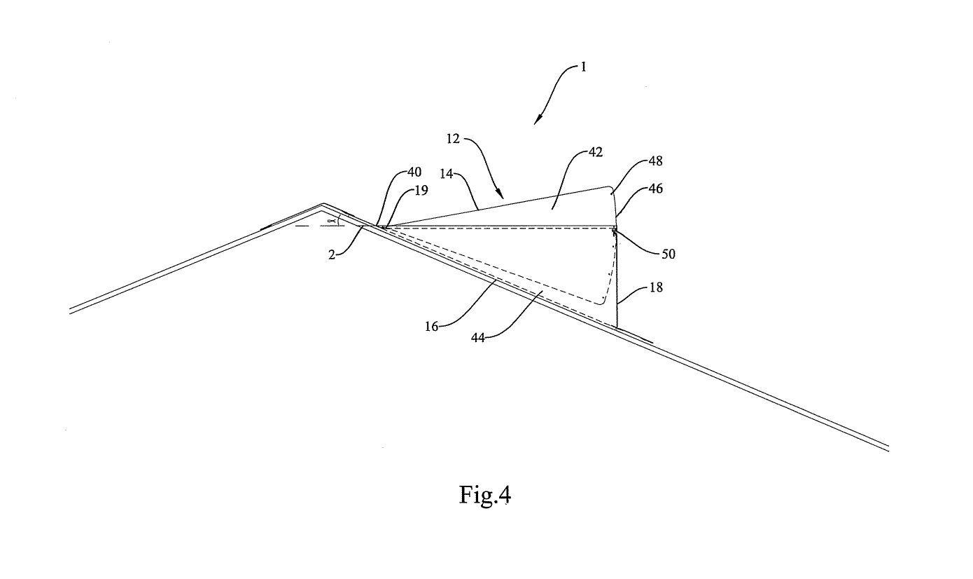

In a second embodiment, shown in FIG. 4, the base 12 has a hinge 40 at the crown end 19 of the top and bottom surfaces 14, 16. As such, the base 12 has a first base portion 42 and a second base portion 44 that rotate about the hinge 40. At the front side 18 of the base 12, the first base portion 42 has a curved end portion 46 that curves downwardly and inwardly toward the roof 2. The curved end portion 46 has sequential apertures 48 adapted to receive a removable locking pin (not shown). The second base portion 44 has a single aperture 50 on the front side 18 to receive the locking pin. The first base portion 42 can then be rotated about the hinge 40 and secured into various positions using the pin in the apertures 48, 50, which allows the roofer to adjust the base 12 to differing angles a to match the incline of the roof 2 and provides a way for the roofer to select how the supply is held in the storage bay 24. For example, the roofer may wish for a slight incline in the opposite direction of the roofs incline. The roofer can adjust the first base portion 42 as desired and place the pin through the aperture 50 of the second base portion 44 and the corresponding aperture 48 of the first base portion 42.

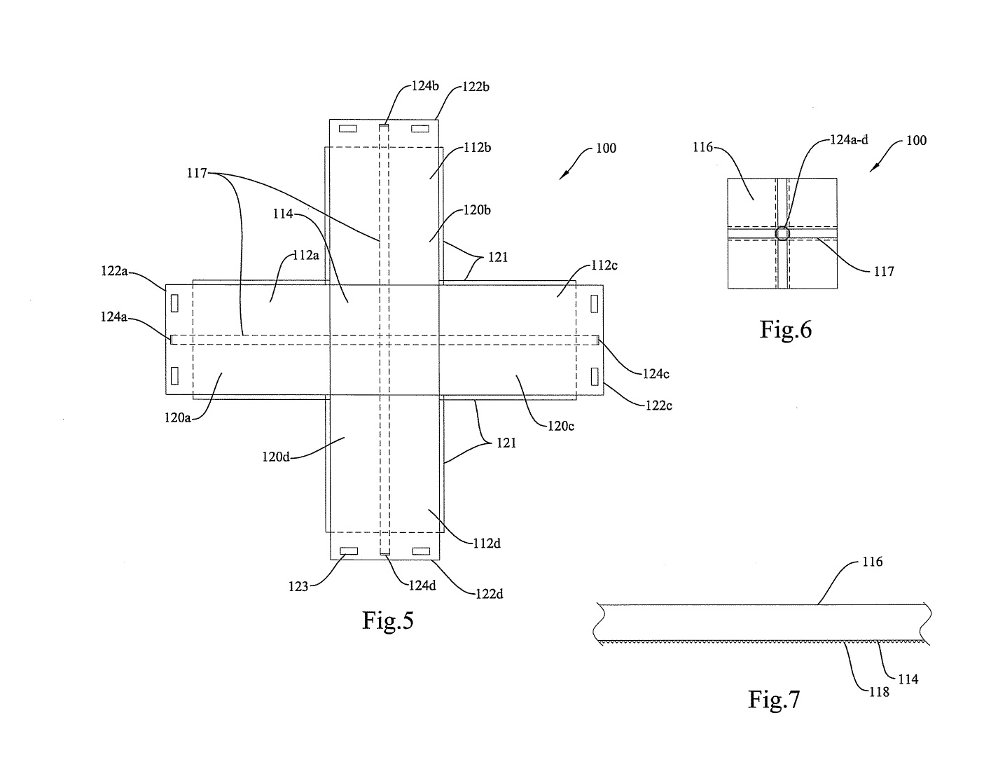

Referring to FIGS. 5-7, the material wrapper 100 is used in conjunction with the work platform 1 and will now be described. The material wrapper 100 is preferably formed from an elastomeric material which retains substantial strength even when stretched and provides a tight, approximately form-fitting enclosure or container that wraps around the supply of tiles or shingles. The roofer can use the material wrapper 100 to secure the supply before lifting from the ground to the roof 2. The material wrapper 100 prevents the supply from spilling or skidding while being hoisted.

The material wrapper 100 includes a midsection 110 sized and configured to receive the supply of tiles or shingles, and a plurality of branches 112a, 112b, 112c, 112d disposed along an edge of the midsection 110 respectively and extending away from the midsection 110. The midsection 110 and the branches 112a, 112b, 112c, 112d each have an interior side 114 with a plurality of traction members 118 disposed thereon and an exterior side 116 having one or more support straps 117 thereon. The support straps 117 are secured to the exterior side 116 of the midsection 110 and branches 112a, 112b, 112c, 112d to provide support when the supply is lifted.

Each of the branches 112a, 112b, 112c, 112d has a base 120a, 120b, 120c, 120d and a top flap 122a, 122b, 122c, 122d, respectively, disposed on the base 120a, 120b, 120c, 120d. The base 120a, 120b, 120c, 120d includes two side flaps 121, one on each side that extend the length of the base 120a, 120b, 120c, 120d. The top flap 122a, 122b, 122c, 122d and the side flaps 121 having hook or loop fastener strips (Velcro) thereon, each of the side flaps 121 mate with an adjacent side flap on an adjacent base 120a, 120b, 120c, 120d. The top flaps 122a, 122b, 122c, 122d have a ring 124a, 124b, 124c, 124d for hoisting the wrapper secured on the exterior side. The top flaps 122a, 122b, 122c, 122d have a slit therethrough to receive one or more rings 124a, 124b, 124c, 124d, which are connected to the support strap 117. The hook or loop fastener strip 123 on an interior of the top flaps 122a, 122b, 122c, 122d mate with the hook or loop fastener strip on the exterior of another corresponding top flap 122a, 122b, 122c, 122d.

The material wrapper 100 is securely wrapped around the supply using the hook and loop fastener strips and the rings 124a, 124b, 124c, 124d. Having wrapped the supply, the roofer may then hoist the material wrapper 100 and its contents to the roof 2 and onto the work platform 1 using the rings 124a, 124b, 124c, 124d.

In another embodiment, the material wrapper 100 is of an elastomeric material that can retain its shape or form (shape memory). In this embodiment, the supply is lowered into the form-retaining material wrapper 100 and the material wrapper 100 is hoisted to the roof 2 and onto the work platform 1.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A work platform to support a supply of tiles or shingles on a roof surface comprising:
an underlying base for supporting the supply, the base having a front side, a top surface and a bottom surface, the bottom surface being disposed intermediate of the front side and the top surface; and
an upright member extending from an end of the front side, the base and the upright member forming a storage bay configured to support the supply in a substantially horizontal position away from the roof surface.

2. The work platform of claim 1, wherein the upright member includes a gate spanning a front side of the storage bay.

3. The work platform of claim 1, wherein the upright member curves at an uppermost end to secure the supply and prevent injury.

4. The work platform of claim 1, further comprising a first secure extension connected to the base and a second secure extension connected to the top surface, wherein the first and second secure extensions are configured to immobilize the base.

5. The work platform of claim 4, wherein the first secure extension includes a thin rectangular bar.

6. The work platform of claim 4, wherein the second secure extension includes a thin rectangular bar having a curved end with apertures.

7. The work platform of claim 6, wherein the curved end has a curvature to substantially conform with a curvature at a crown of the roof.

8. The work platform of claim 1, wherein the bottom surface includes a friction layer to prevent the base from sliding.

9. A work platform to support a supply of tiles or shingles on a roof surface comprising:
a first base portion having a top surface for supporting the supply and a curved end portion with sequential apertures thereon;
a second base portion rotatably connected to the first base portion, and having an aperture configured and arranged to receive a locking pin and align with one of the apertures of the first base portion at an end portion, the second base including a bottom surface intermediate the curved end portion.

10. The work platform of claim 9, further comprising a first secure extension connected to the base and a second secure extension connected to the top surface, wherein the first and second secure extensions are configured to immobilize the base.

11. The work platform of claim 10, wherein the first secure extension includes a thin rectangular bar.

12. The work platform of claim 10, wherein the second secure extension includes a thin rectangular bar having a curved end with apertures.

13. The work platform of claim 12, wherein the curved end has a curvature to substantially conform with a curvature at a crown of the roof.

14. The work platform of claim 9, wherein the bottom surface includes a friction layer to prevent the base from sliding.

15. A material wrapper for a supply of tile or shingles comprising:
a midsection; and
four or more branches, each including a base connected to the midsection and a top flap connected to the base opposite the midsection, the base including at least one side flap configured and arranged to mate with an adjacent side flap on an adjacent base.

16. The material wrapper of claim 15, wherein the flap includes a ring secured on an exterior side.

17. The material wrapper of claim 16, wherein the flap has a slit to receive one or more rings from the flaps.

18. An assembly comprising:
a work platform including
an underlying base for supporting the supply, the base having a front side, a top surface and a bottom surface, the bottom surface being disposed intermediate of the front side and the top surface; and
an integral, unitary one-piece material wrapper including
a midsection, and
four or more branches, each including a base connected to the midsection, the base being connected to an adjacent base.
